(19) United States
(12) Patent Application Publication
(10) Pub. No.: US 2006/0161327 A1
(43) Pub. Date: Jul. 20, 2006

(54) Wheel sensor for detecting a vehicle motion

(76) Inventors: Harald Emmerich, Reutlingen (DE); Hans-Peter Klose, Stuttgart (DE)

Correspondence Address: KENYON & KENYON LLP, ONE BROADWAY, NEW YORK, NY, 10004, US

(21) Appl. No.: 11/330,736

(22) Filed: Jan. 11, 2006

(30) Foreign Application Priority Data
Jan. 18, 2005 (DE) 102005002240.5

(51) Int. Cl. B60T 7/12

(52) U.S. Cl. 701/78

(57) ABSTRACT

A device for measuring a motion of a vehicle includes an acceleration sensor situated on a wheel and an appertaining evaluation circuit. The sensor system operates especially accurately and reliably if the acceleration sensor is mounted on the wheel in such a way that the main sensing direction lies essentially in the tangential direction of the wheel.

### FIELD OF THE INVENTION

The present invention relates to a sensor mounted on a wheel for detecting the state of motion of a vehicle, as well as a motor vehicle having such a sensor.

### BACKGROUND INFORMATION

As a rule, modern vehicles include various sensors that monitor the state of vehicle components and, during standstill of the vehicle, are switched to standby operation. From the related art, for instance, a tire pressure monitoring system is known which includes several tire pressure sensors which, together with a transmission electronics system are situated in the wheels of a motor vehicle, and, in case of a pressure loss, they send a radio signal to a control unit. The tire pressure monitoring system is supplied with electric power by a battery that is also contained in the wheel. For energy-saving reasons, at standstill of the vehicle, the tire pressure sensor is in standby operation, and is only switched to active when driving operation is taken up again. In order to realize this activation function or deactivation function, as a rule, known systems have a sensor system with which the state “driving operation” or “vehicle standstill” may be recognized.

From the related art, it is known that one may mount an acceleration sensor on the wheel for this, that measures the centrifugal acceleration of the wheel. Thereby it may be detected in a simple manner whether the vehicle is moving or not. This wheel sensor has the disadvantage that it has a relatively high detection threshold, and consequently it can only detect vehicle motion from a relatively high speed on.

Therefore, it is an object of the present invention to provide a wheel sensor, for detecting the state of motion of a vehicle, which has a greater accuracy.

### SUMMARY OF THE INVENTION

An important idea of the present invention is to provide an acceleration sensor at the wheel which measures the tangential acceleration of the wheel, and to evaluate its sensor signal so as to detect the state of motion. The acceleration sensor according to the present invention is mounted in such a way that the main sensing direction is in the tangential direction with respect to a wheel circumference. Measuring the tangential acceleration has the important advantage that the size of the measuring range in comparison to the measurement of the centrifugal acceleration is substantially smaller, and the measuring range may consequently be resolved better. It is therefore possible to measure even smaller vehicle speeds at a greater accuracy.

The wheel sensor according to the present invention may, for example, be used to control the state of a wheel pressure monitoring system, and to switch the wheel pressure from an inactive state (e.g. from standby) to an active state upon detection of a vehicle motion, and vice versa. Of course, the motion sensor according to the present invention may also be used to activate and deactivate other systems.

The output signal of the sensor according to the present invention is preferably processed by an evaluation circuit that is also situated in the wheel. In the case of an analog sensor signal, the signal is preferably scanned (sampled) at a predefined scanning frequency. The evaluation circuit preferably calculates the difference between two scanning values, and carries out a threshold value comparison so as to detect a vehicle motion.

The evaluation circuit is preferably designed in such a way that a vehicle motion is detected if the difference of two scanning values exceeds a predefined threshold value of, for instance, 100 mG. Big differences between two scanning values are an indication of a quick driveaway or a rapid acceleration. In this case, the evaluation circuit preferably directly generates an output signal by which an appertaining subsystem, such as a tire pressure monitoring system, is activated.

In the case of small differences, the evaluation circuit preferably switches into a second measuring mode in which the sensor signal of the acceleration sensor is evaluated more accurately. Small differences are, as a rule, to be observed if the vehicle starts slowly or brakes, but also if the scanning frequency is selected unfavorably with respect to the sensor signal (aliasing). In the second measuring mode, for example, a higher scanning frequency may be selected and/or a zero crossing detection may be carried out. Optionally, the scanning values may also be measured at a higher resolution. What is important is that the inaccurate or the non-unique result is checked once more in a second, more accurate measuring mode.

According to another specific embodiment of the present invention, the evaluation circuit is implemented in such a way that it scans the acceleration signal of the acceleration sensor at an irregular scanning frequency. The scanning points in time may be generated, for instance, using a random generator. An irregular scanning has the advantage that the sinusoidal signal of the acceleration sensor is not randomly scanned always at the same point (that is, the difference of two measured values is equal to zero, although the vehicle is accelerating) and consequently faulty measurements are able to be avoided.

According to one special specific embodiment of the present invention, the acceleration sensor is situated at the wheel in such a way that its main sensing direction deviates little from the tangential direction. The deviation is preferably less than 10°. In this case, the acceleration sensor also measures a small proportion of the centrifugal acceleration. Thereby it is possible to detect a vehicle motion if the absolute value of the sensor signal exceeds a predefined threshold value.

### BRIEF DESCRIPTION OF THE DRAWINGS

FIG. 1 shows a schematic block diagram of a system for tire pressure monitoring having a motion sensor.

FIG. 2a shows a schematic representation of a motion sensor fastened to the wheel at standstill of the vehicle.

FIG. 2b shows the measuring signal of the motion sensor of FIG. 2a in various positions.

FIG. 3a shows a schematic representation of a motion sensor fastened to a wheel during an acceleration procedure.

FIG. 3b shows a signal curve of the motion sensor of FIG. 3a during an acceleration procedure.

FIG. 4a shows a schematic representation of a motion sensor which is mounted on the wheel slightly outside the tangential direction.

FIG. 4b shows the appertaining signal curve of the motion sensor of FIG. 4a.

FIG. 5 shows the method steps during the evaluation of the sensor signal.

### DETAILED DESCRIPTION

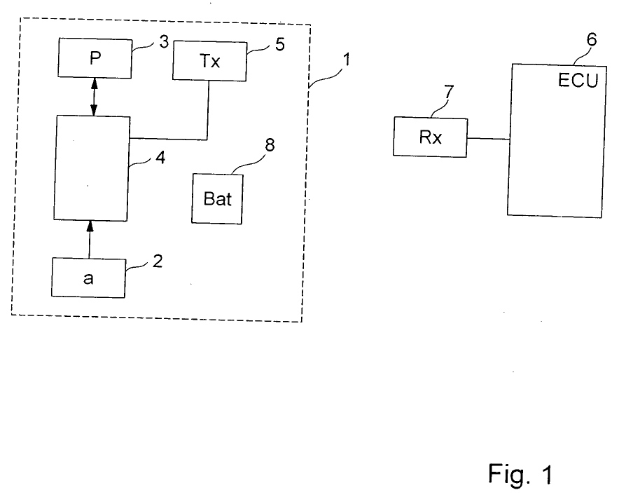

FIG. 1 shows a schematic representation of a system 3,4,5 for tire pressure monitoring using a motion sensor 2 integrated into wheel 1. The tire pressure monitoring system 3,4,5 includes essentially a pressure sensor 3, an evaluation circuit 4 and a transmitter 5, which communicates with a receiver 7 that is situated in the vehicle.

During driving operation, pressure sensor 3 measures the tire pressure and generates a corresponding analog output signal which is processed by evaluation circuit 4. The current pressure value is transmitted to receiver 7 and external control unit 6, using transmitter 5. In response to a pressure loss, the driver may consequently be warned, or other safety measures may be taken. Components 2-5 are supplied with electric power by a battery 8, which is also situated in wheel 1.

For reasons of energy savings, the tire pressure monitoring system is devised in such a way that it is active only in driving operation. However, during standstill of the vehicle, which, as a rule, makes up by far the greatest proportion in time, the system is switched to standby mode. The state of “driving operation” or “vehicle standstill” is detected here with the aid of motion sensor 2, which measures the tangential acceleration of wheel 1. The output signal of sensor 2 is scanned by evaluation circuit 4 and evaluated.

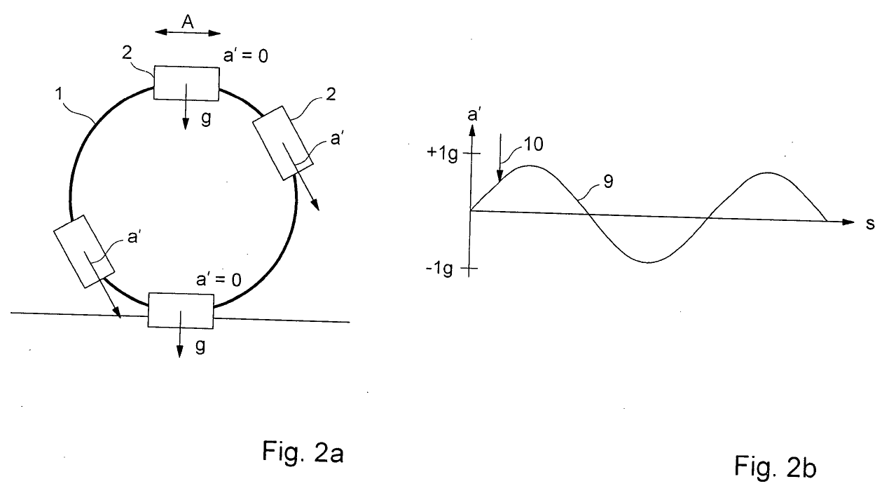

FIG. 2 shows a schematic representation of a motor vehicle wheel 1 having an acceleration sensor 2, which is shown in altogether four different positions. Acceleration sensor 2 is fastened to wheel 1 in such a way that its main sensing direction A lies in the tangential direction with respect to a wheel circumference. During standstill of the vehicle, which is shown here, acceleration sensor 2 measures in each position only one tangential component a′ of the acceleration of gravity. At the highest and the lowest point of the wheel, therefore, the measured value is a′=0, and at the front-most (most to the right) and rear-most (most to the left) point a′=g or a′=−g.

The appertaining signal curve 9 is shown in FIG. 2b. As may be seen, signal 9 has a sinusoidal shape and fluctuates between the two extreme values +g and −g.

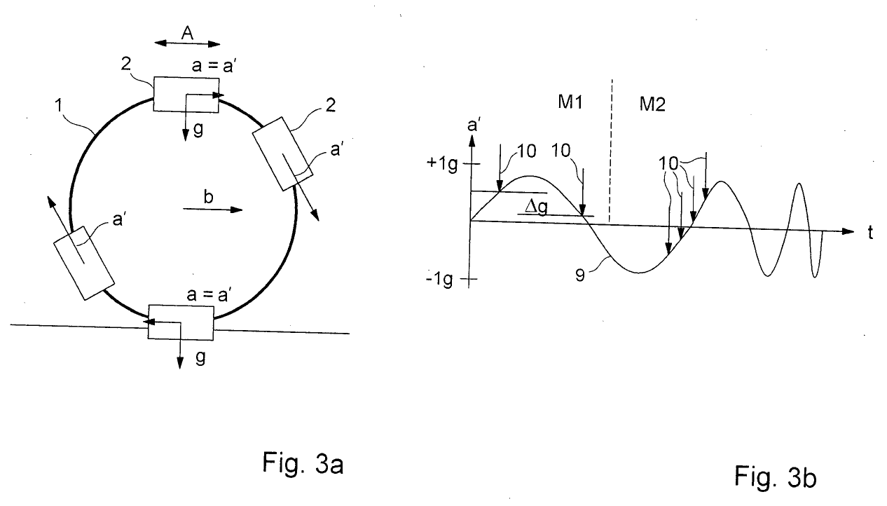

FIG. 3 shows the wheel with acceleration sensor 2 at an acceleration procedure in the direction of arrow b. The acceleration sensor in each case measures tangential wheel acceleration a, which is superposed by gravity acceleration g.

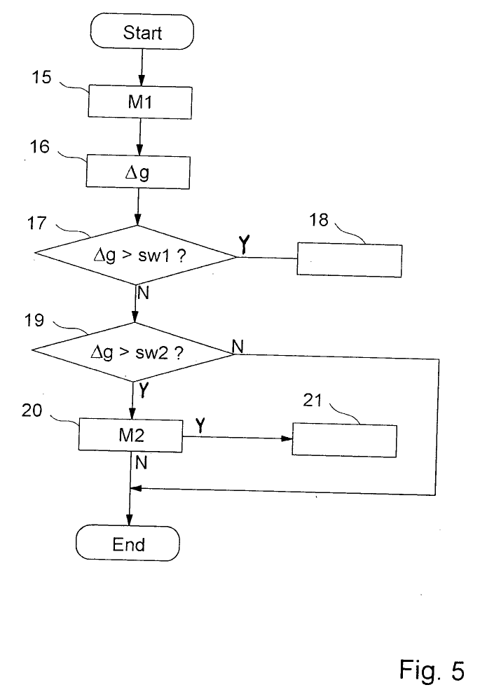

FIG. 3b shows the appertaining signal curve of acceleration sensor 2. This signal 9 is scanned by evaluation circuit 4 in first measuring mode M1 at a predefined, relatively low scanning frequency. The scanning values are labeled with reference numeral 10. Evaluation circuit 4 calculates, from two consecutive scanning values, in each case a difference Δg, and determines from this whether the vehicle is moving or not. For this, for example, the method shown in FIG. 5 may be carried out.

FIG. 5 shows the important method steps of the method in the form of a flow diagram. In a first step 15, sensor signal 9 is first scanned in a first measuring mode M1, using a relatively low scanning frequency. In step 16, the difference Δg is calculated from two consecutive measured values, and in step 17 a threshold value comparison is carried out. If the difference Δg is very great, in this case greater than a relatively high threshold value SW1 of, for instance, 100 mG, a vehicle motion is considered as being detected, and in step 18 an output signal is generated directly, for activating the wheel pressure monitoring system 3,4,5. Inasmuch as the difference Δg is less than threshold value SW1 (case N), it is checked in step 19 whether the difference Δg is greater than a second, smaller threshold value SW2 of, for instance, 20 mG.

Relatively small differences Δg appear especially in response to a slow vehicle motion, but they also appear if the scanning frequency is selected unfavorably, so that, in spite of a rapid vehicle motion, only scanning values having approximately the same value are taken up, or the scanning theorem is injured (aliasing). In the case of detected small differences, therefore, it is meaningful for energy savings reasons (unnecessary transmission), to differentiate using a second measuring mode M2 between artifacts and an actual vehicle motion. In order to check the first measurement, evaluation circuit 4 switches in step 20 into a second, more accurate measuring mode M2, in which signal 9 is evaluated more accurately. In second measuring mode M2, for example, a higher scanning frequency may be used, and, in turn, a difference Δg may be evaluated and/or a zero crossing detection may be carried out. Optionally, scanning values 10 may also be measured at a higher resolution.

If the evaluation in second measuring mode M2 yields a vehicle acceleration (case J), in step 21 an output signal is generated for activating the wheel pressure monitoring system 3-5. Otherwise the method ends.

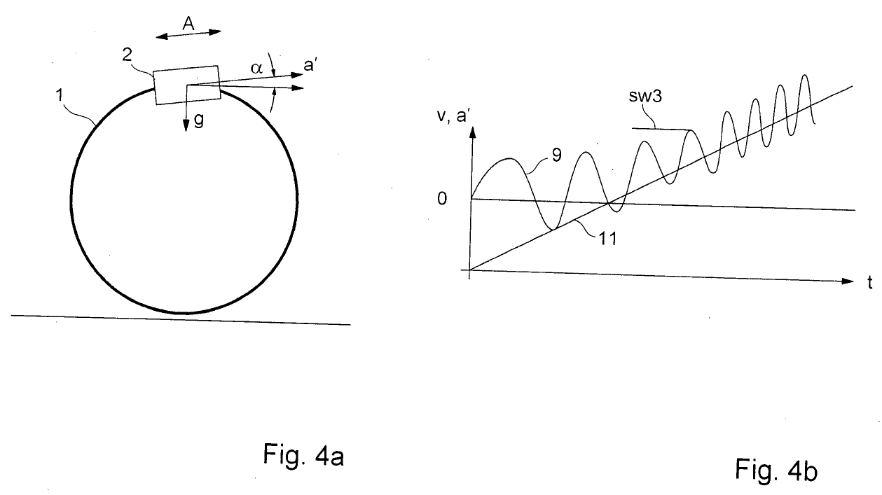

FIG. 4a shows a schematic representation of a motor vehicle wheel 1, in which acceleration sensor 2 is mounted in such a way that its main sensing direction deviates slightly from the tangential direction. The difference angle is here denoted as the angle α, and is preferably smaller than 10°. Acceleration sensor 2 thus measures, besides the tangential proportion, also a slight proportion of the centrifugal acceleration, which may be evaluated.

FIG. 4b shows the appertaining output characteristics curve 9 of sensor 2 during a driveaway procedure having constant acceleration, the vehicle speed rising steadily (characteristics curve 11). Based on the increasing centrifugal forces, the absolute value measured by acceleration sensor 2 also rises. In this specific embodiment it is therefore possible to detect a vehicle motion by evaluating the absolute value of measuring signal 9. If the absolute value exceeds a predefined threshold value SW3, the vehicle motion is considered as having been detected.

Alternatively or in addition, for example, a signal evaluation may also be carried out as it was explained above with respect to 5.

### LIST OF REFERENCE SYMBOLS

1 wheel
2 acceleration sensor
3 tire pressure sensor
4 evaluation unit
5 transmitter
6 control unit
7 receiver
8 battery
9 sensor signal
10 scanned values
11 vehicle speed
15-22 method steps
SW1, SW2 threshold values
a′ acceleration measured value
g gravity acceleration
t Time

What is claimed is:

1. A device for detecting a state of motion of a vehicle, comprising:
an appertaining evaluation circuit; and
an acceleration sensor mounted on a wheel of the vehicle in such a way that a main sensing direction is substantially in a tangential direction.

2. The device according to claim 1, wherein the evaluation circuit calculates a difference between two acceleration values and evaluates the difference, so as to establish a vehicle motion.

3. The device according to claim 2, wherein the evaluation circuit generates an output signal for activating a wheel pressure monitoring system if the difference is greater than a predefined threshold value.

4. The device according to claim 2, wherein the evaluation circuit switches over into a second, more accurate measuring mode if the difference satisfies a predefined condition.

5. The device according to claim 4, wherein the evaluation circuit in the second measuring mode evaluates measured values that lie closer together in time.

6. The device according to claim 4, wherein the evaluation circuit in the second measuring mode carries out a zero crossing detection.

7. The device according to claim 1, wherein the evaluation circuit scans an output signal of the acceleration sensor at an irregular scanning frequency.

8. The device according to claim 1, wherein the acceleration sensor is mounted with the main sensing direction deviating from the tangential direction.

9. The device according to claim 8, wherein the evaluation circuit detects a vehicle motion if an absolute value of a sensor signal exceeds a predefined threshold value.

10. A motor vehicle wheel comprising:
an appertaining evaluation circuit; and
an acceleration sensor mounted on the wheel in such a way that a main sensing direction lies substantially in a tangential direction of the wheel.
